(19) United States
(12) Patent Application Publication
(10) Pub. No.: US 2026/0205458 A1
(43) Pub. Date: Jul. 16, 2026

(54) CONFIGURING ACCESS CONTROL RULES AT SWITCHES

(71) Applicant: Hewlett Packard Enterprise Development LP, Spring, TX (US)

(72) Inventors: Chandrashekar Chikkalingaiah Manchanapura, Bangalore (IN); Kishor Kumar Chandrappa, Bangalore (IN); Krishna Babu Puttagunta, Rocklin, CA (US); Prateek Sarnad, Bangalore (IN)

(21) Appl. No.: 19/075,983

(22) Filed: Mar. 11, 2025

(30) Foreign Application Priority Data
Jan. 10, 2025 (IN) 202511002576

(51) Int. Cl. H04L 9/40; H04L 41/12; H04L 67/1097

(52) U.S. Cl. CPC H04L 63/101; H04L 41/12; H04L 67/1097

(57) ABSTRACT

In some examples, a system receives, at a controller, information from a client device as part of a registration process by the client device with the controller, the information received from the client device including switch information of a switch to which the client device is connected, the switch being part of a network fabric that connects client devices to destination devices. Based on the switch information, the system identifies the switch from among a plurality of switches of the network fabric as a target to configure an access control rule for a zone including the client device. The system configures, at the switch, the access control rule for the zone.

### BACKGROUND

Storage devices of a network system are accessible to compute nodes over a network fabric. The network fabric includes switches through which the compute nodes can communicate with storage devices.

### BRIEF DESCRIPTION OF THE DRAWINGS

Some implementations of the present disclosure are described with respect to the following figures.

FIG. 1 is a block diagram of an arrangement including host devices, storage devices, switches of a network fabric, a controller, and a management system, according to some examples.

FIG. 2 is a flow diagram of a process of configuring an access control rule at a switch, according to some examples.

FIG. 3 is a block diagram of a storage medium storing machine-readable instructions according to some examples.

FIG. 4 is a block diagram of a client device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In a network system, zones may be defined, where a zone includes a collection of electronic devices, such as one or more compute nodes (host devices) and one or more storage devices. Zones support data privacy and/or security by controlling interactions among devices (e.g., host devices and storage devices) in different zones. Access control rules (also referred to as “access control lists” or “zone rules”) can be defined for the respective zones. The access control rules can specify whether a source device (e.g., a host device) is permitted to communicate with a destination device (e.g., a storage device. For example, an access control rule can permit a source device in a given zone to communicate with a destination device in the given zone. Access control rules may be applied at switches of the network fabric as the switches receive data packets from source devices that are targeted at destination devices. Defining zones based on enforcing access control rules at switches of the network fabric can be referred to as “hard zoning.”

A zone can be based on a combination of parameters that may be present in a data packet sent from a source device to a destination device, including for example, a source Internet Protocol (IP) address, a destination IP address, a communication protocol, a port number, a source device identifier, and a destination device identifier. In some examples, zones may be configured manually by an administrator or another user at switches of a network fabric through a management interface that allows the administrator or other user to communicate with the switches. However, manual configuration of zones may be time consuming or error prone, especially in a large network fabric with many switches. Further, it may be difficult to identify which switches specific access control rules are to be placed. There may be many switches along multiple hops (network segments) in a network fabric, which can make it challenging to determine which of the switches along the multiple hops is the optimal switch at which a particular access control rule is to be provided. Providing access control rules at all switches in the network fabric is inefficient as configuring access control rules at switches is associated with management overhead and consumes resources of the switches.

In accordance with some implementations of the present disclosure, a client device obtains switch information of a switch to which the client device is connected. The client device passes the switch information to a controller during a registration process by the client device with the controller. A “client device” may refer to any electronic device that is able to participate in a registration process with the controller. For example, a client device may include a host device that is to access a storage device. More generally, a client device may include any other type of source device that is able to initiate communication with a destination device.

A configuration engine identifies the switch from among multiple switches of a network fabric based on the switch information provided by the client device during the registration process. The configuration engine configures the access control rule for the zone on the identified switch. For data packets transmitted by the client device, the identified switch is the ingress switch, i.e., the first switch that receives the data packets from the client device. The ingress switch can determine, based on the access control rule, whether a given data packet from the client device is to be forwarded further in the network fabric. If so, the given data packet can be forwarded to another switch or to a destination device.

In accordance with some examples of the present disclosure, by selectively configuring access control rules at selected switches (e.g., ingress switches) for respective zones, the access control rules would not have to be configured across all switches in the network fabric. Configuring access control rules across all switches may be inefficient and consumes switch resources. Moreover, enforcing access control rules at ingress switches may be more efficient in scenarios where the access control rules cause some data packets to be dropped. Enforcing an access control rule at an ingress switch that causes a data packet to be dropped (i.e., not further forwarded) means that the data packet would not have to be propagated further in the network fabric past the ingress switch. The dropped data packet would not consume further network bandwidth and resources.

A “switch” can refer to any of the following: a layer 2 switch that forwards data packets based on layer 2 network addresses, such as Media Access Control (MAC) addresses; a layer 3 router that forwards data packets based on layer 3 network addresses, such as Internet Protocol (IP) addresses; or any other network device that forwards data packets along selected network paths based on information in the data packets.

An “access control rule” (also referred to as an “access control list” or a “zone rule”) refers to any information that defines a criterion or a constraint determining whether a client device is permitted to communicate with a destination device. For example, the access control rule may identify destination device(s) to which data packets from a source device may be sent. If a data packet from the client device specifies a destination device that is not identified in the access control rule, then a switch that is the enforcement point for the access control rule can drop the data packet. Further, if the switch receiving a data packet from a particular client device does not include any access control rule for the particular client device, the switch can drop the data packet.

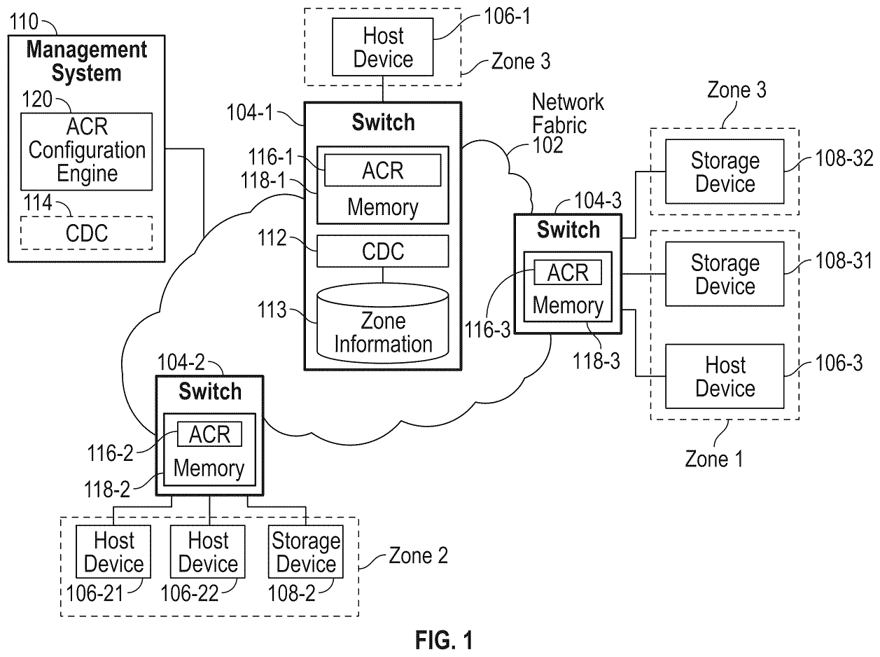

FIG. 1 is a block diagram of an example arrangement that includes a network fabric 102 connecting host devices and storage devices. The host devices are examples of source electronic devices that can interact with destination electronic devices (which in FIG. 1 include the storage devices). An “electronic device” can refer to any or some combination of the following: a computer (e.g., a desktop computer, a notebook computer, a tablet computer, etc.), a smartphone, a game appliance, a household appliance, an Internet of Things (IoT) device, a vehicle, or any other type of electronic device.

The network fabric 102 includes switches 104-1, 104-2, and 104-3 that are connected to host devices or storage devices. Although specific quantities of switches, host devices, and storage devices are depicted in FIG. 1, in other examples, different quantities of switches, host devices, or storage devices may be present.

The switch 104-1 is connected to a host device 106-1, the switch 104-2 is connected to host devices 106-21, 106-22 and a storage device 108-2, and the switch 104-3 is connected to a host device 106-3 and storage devices 108-31, 108-32.

A management system 110 performs management tasks with respect to the switches 104-1 to 104-3 of the network fabric 102. In some examples, the management system 110 may also present an interface to allow user access to the switches 104-1 to 104-3. For example, the interface may be a web interface accessible to users for accessing the switches 104-1 to 104-3. The management system 110 may be implemented with one or more computers. In some examples, the management system 110 may include a management server that executes program code to perform the management tasks, and a management station to present to interface to allow user access to the switches 104-1 to 104-3.

In some examples, one or more centralized discovery controllers (CDCs) may be provided. A CDC is a standards-based controller that provides fabric services for discovery automation, such as in a network fabric that supports the Non-Volatile Memory Express over Fabrics (NVMe-oF) protocol. The CDC supports registration of client devices (e.g., the host devices shown in FIG. 1) and zoning that defines zones of devices. Functionalities of the CDC are described in the NVMe-OF standard. In some examples, the network fabric 102 provides an IP-based transport in which IP packets are used to exchange data and control information.

In the example of FIG. 1, a CDC 112 is included in the switch 104-1. In such examples, the management system 110 can interact with the CDC 112 in the switch 104-1. In further examples, the CDC 112 (or an additional CDC) may be included in another switch. In alternative examples, instead of or in addition to providing the CDC 112 in a switch, a CDC 114 may be included in the management system 110.

In some examples, the CDC 112 or 114 may run as a container or a virtual machine (VM) in the switch 104-1 or the management system 110, respectively. In other examples, the CDC 112 or 114 can be implemented using machine-readable instructions executable by a processing resource of the switch 104-1 or the management system 110, respectively.

Although reference is made to a CDC, in other examples, other types of controllers can be used to manage registration of client devices as well as to define zones of devices.

In the example of FIG. 1, three zones are defined. Zone 1 includes the host device 106-3 and a storage device 108-31, zone 2 includes the client devices 106-21, 106-22 and the storage device 108-2, and zone 3 includes the host device 106-1 and the storage device 108-32. Note that a zone can include any number of devices. Also, in other examples, a different quantity (one or more) of zones may be defined.

The CDC 112 maintains zone information 113 (which can be stored in the switch 104-1) that defines zones 1, 2, and 3. The zone information 113 may be in the form of a zone database or another data structure. The zone information identifies zone members that are members of each zone. For example, the zone information can include the IP addresses of the zone members. In the example of FIG. 1, a zone member can be a host device or a storage device. More generally, a zone member may be any type of electronic device. Note also that a zone member may be a virtual device, such as a VM.

The CDC 114 (if present) may similarly maintain zone information (not shown) stored in the management system 110.

As noted above, a zone can be based on a combination of parameters that may be present in a data packet sent from a source device to a destination device, including for example, a source IP address, a destination IP address, a communication protocol, a port number, a source device identifier, and a destination device identifier. The source IP address identifies a source device, e.g., a host device. The destination IP address identifies a destination device, e.g., a storage device. The communication protocol is a protocol used for the communication of the data packet. For example, the communication protocol can be a Transmission Control Protocol (TCP) or a User Datagram Protocol (UDP).

The port number identifies a port (e.g., TCP port or UDP port). For example, the port number may be TCP port 4420, which is designated for NVMe-OF communications. In other examples, other port numbers may be used for indicating that the data packet is associated with a host device accessing a storage device.

The source device identifier identifies a source device, e.g., a host device, and the destination device identifier identifies a destination device, e.g., a storage device. In some examples, the source and destination device identifiers may be relatively short local identifiers (e.g., 4 bytes in length or another short length) that identify respective devices. For example, in assigning a local identifier to a device (e.g., a host device or a storage device), the CDC (e.g., 112 or 114) may apply a function (e.g., a hash function) to a global identifier of the device to generate the local identifier that is unique within a network system. The global identifier may be much longer than the local identifier. For example, the global identifier may be a network qualified name (NQN), which can have a length of 224 bytes or another long length. A global identifier may uniquely identify a device across multiple network systems. On the other hand, a local identifier may uniquely identify a device within a network system (but duplicate local identifiers may be used across multiple network systems).

A “network system” can refer to any collection of electronic devices (e.g., host devices and storage devices or other types of devices) that may be part of a defined environment that is separate from another network system. For example, different network systems may be operated by different providers or otherwise are physically or logically separated from one another.

Source and destination device identifiers (local identifiers or global identifiers) may be included in data packets sent from a source device to a destination device. A switch may parse a data packet to derive the source and destination identifiers as well as other parameters (e.g., a source IP address, a destination IP address, a communication protocol, and a port number) to determine a zone that the data packet is being communicated in. This determined zone corresponds to a respective access control rule (ACR) that is to be enforced by the switch.

A switch in the network fabric 102 can enforce the ACR to filter data traffic on a packet-by-packet basis. In response to receiving a data packet at the switch from a host device, the switch can apply an ACR to determine whether to allow the data packet to be forwarded to a destination device specified in the data packet, or alternatively, apply another action to the data packet (e.g., drop the data packet or modify the data packet). In further examples, if the switch does not include an ACR that is applicable to the host device, the switch may drop the data packet.

The management system 110 can be used to configure ACRs in respective switches. “Configuring” an ACR in a switch refers to adding or updating the ACR in the switch. In the example of FIG. 1, an ACR 116-1 is configured in the switch 104-1, an ACR 116-2 is configured in the switch 104-2, and an ACR 116-3 is configured in the switch 104-3. Although each switch is shown as being configured with one ACR, it is noted that there may be multiple ACRs configured in each switch to control access by host devices of storage devices in respective zones. The ACR 116-1 is stored in a memory 118-1 of the switch 104-1, the ACR 116-2 is stored in a memory 118-2 of the switch 104-2, and the ACR 116-3 is stored in a memory 118-3 of the switch 104-3.

In some examples, the management system 110 includes an ACR configuration engine 120 that can configure ACRs on selected switches. In other examples, the ACR configuration engine 120 may be included in a switch; for example, the ACR configuration engine 120 may be part of the CDC 112 included in the switch 104-1. In the ensuing discussion, it is assumed that the ACR configuration engine 120 is part of the management system 110 and is separate from a CDC.

When an ACR configuration process is initiated, the ACR configuration engine 120 can intelligently identify a switch on which an ACR is to be placed. For example, the ACR configuration engine 120 can place the ACR for a given host device on a switch that is connected to the given host device. In some examples of the present disclosure, the identification of the switch on which the ACR is to be placed can be based on a policy of configuring ACRs at ingress switches. The intelligent placement of ACRs on switches can reduce the number of switches on which the ACRs are placed, which increases the efficiency of ACR placement in terms of processing time and resource usage. Also, placing ACRs at ingress switches can improve the efficiency associated with enforcement of ACRs, because if a data packet is dropped due to application of an ACR, the dropped data packet would not consume any further network bandwidth or resource beyond the ingress switch.

Although the zone information 113 maintained by the CDC 112 identifies zone members that are part of respective zones, the zone information 113 does not provide any information regarding switches to which zone members are connected. As a result, the ACR configuration engine 120 is unable to determine from the zone information 113 which switch is the optimal target for configuring an ACR for a given host device.

To address the foregoing issue, when an ACR configuration process is initiated for a host device, the ACR configuration engine 120 obtains switch information identifying the switch to which the host device is connected. The switch information is provided by the host device to the CDC 112 in a registration process to register the host device with the CDC 112. The switch information is provided to the ACR configuration engine 120, which uses the switch information to identify the switch on which the ACR for the host device is placed.

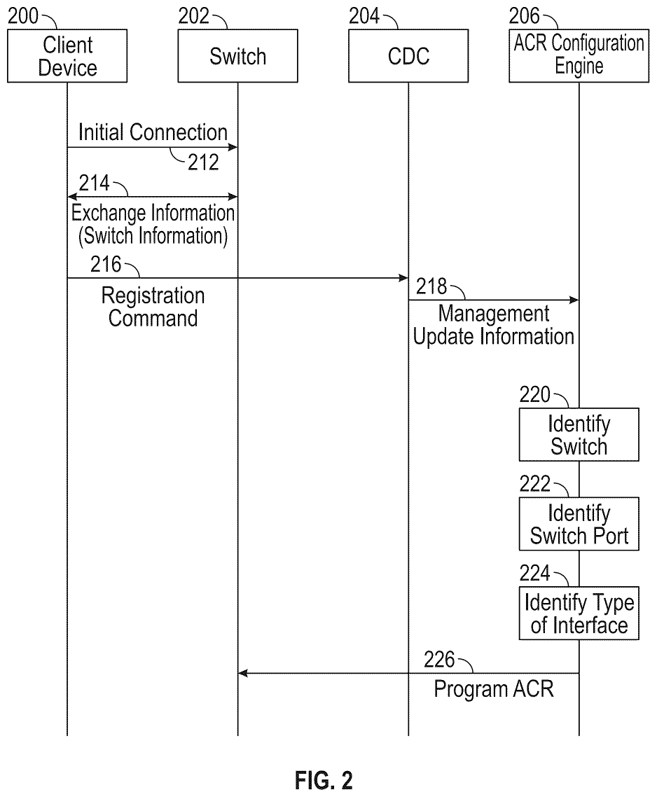

FIG. 2 is a flow diagram of a process that involves a client device 200, a switch 202 to which the client device 200 is connected, a CDC 204, and an ACR configuration engine 206. The client device 200 may be any of the host devices in FIG. 1. Alternatively, the client device 200 may be any source electronic device that is able to initiate communication with a destination electronic device.

The switch 202 may be any of the switches 104-1 to 104-3 in FIG. 1. The CDC 204 may be the CDC 112 or 114 in FIG. 1. The ACR configuration engine 206 may be the ACR configuration engine 120 in FIG. 1.

The client device 200 can establish an initial connection (at 212) to the switch 202. The initial connection can refer to the very first time that the client device 200 connects to the switch 202, or the initial connection can refer to a re-connection of the client device 200 to the switch 202 after the client device 200 as terminated a prior connection.

In response to the initial connection, the client device 200 and the switch 202 can exchange (at 214) information with one another. In some examples, the exchange of information can use Link Layer Discovery Protocol (LLDP) messages. LLDP messages are used by electronic devices (in this case the client device 200 and the switch 202) to advertise their identities, capabilities, and neighbors on a network. The identity advertised by the switch 202 to the client device 200 may include a switch IP address of the switch 202. More specifically, the switch IP address can be the management IP address of the switch 202, which is the IP address of the switch 202 used in management operations, including the configuration of an ACR. The switch 202 can also advertise other switch information (discussed further below) to the client device 200.

In other examples, instead of using LLDP messages, messages according to other protocols may be employed. A “protocol” can refer to a standardized protocol as established by a standards body, an open-source protocol, or a proprietary protocol.

After obtaining the switch information, including the switch IP address of the switch 202, the client device 200 initiates a registration process with the CDC 204, such as by sending (at 216) a registration command to the CDC 204. A “registration process” refers to a process by which a client device provides information associated with the client device to a registrar (in this example the CDC 204) so that the registrar becomes aware of the client device. A “command” can refer to a message or an information element specifying that the registration process is to start.

In some examples, the registration process is a Discovery Information Management (DIM) registration process, as described in the NVMe standard. In the DIM registration process, the client device 200 sends a DIM command to register (or deregister) the client device 200 with the CDC 204.

The DIM command includes various attributes. One of the attributes contains a host identifier (ID), which may be the IP address of the client device 200 or another type of ID of the client device 200. In accordance with some examples of the present disclosure, the DIM command can also include extended attributes to carry switch information in the DIM command sent from the client device 200 to the CDC 204. An “extended attribute” of a command can refer to any attribute that is not yet defined by a current version of a protocol.

In some examples, the extended attributes of the DIM command can include the switch IP address of the switch 202. In further examples, the extended attributes of the DIM command can include additional switch information, such as a switch port name (e.g., in the form of an alphanumeric or numeric string) of a port of the switch 202, and a switch vendor name (e.g., in the form of an alphanumeric or numeric string) identifying a vendor or manufacturer of the switch 202. In these further examples, the switch port name and the switch vendor name can be included as part of the switch information advertised by the switch 202 to the client device 200 as part of the exchange of information (at 214).

The extended attributes in the DIM command are listed in Table 1 below.

TABLE 1
(Extended Attributes)

Switch IP Address
Switch Port Name
Switch Vendor Name

Based on the registration process initiated by the registration command, the CDC 204 is provided with the host ID of the client device 200 and the switch information of the switch 202 to which the client device 200 is connected. At this point, the CDC 204 can send (at 218) management update information to the ACR configuration engine 206. The management update information is to trigger the ACR configuration engine 206 to begin an ACR configuration process.

The management update information may be in the form of a file or any other type of data structure. In a specific example, the management update information may be in the form of a JavaScript Object Notation (JSON) object.

The management update information may include the information listed in Table 2 below, for example.

TABLE 2
(Management Update Information)

Switch IP Address
Switch Port Name
Switch Vendor Name
Communication Protocol
(e.g., TCP)
Source IP Address (IP
address of client device 200)
Source Device Identifier (local
or global identifier of client
device 200)
Allowed Destination(s):
Destination IP Address
Port Number (e.g.,
TCP port 4420)
Destination Device
Identifier (local or
global identifier of the
destination device)

The “Allowed Destination(s)” section of the management update information can identify one or more destination devices. To identify multiple destination devices, the “Allowed Destination(s)” section of the management update information can include multiple destination IP addresses and multiple destination device identifiers. Parts of the management update information (e.g., the source IP address, the source device identifier, and the information in the “Allowed Destination(s)” section(s)) may be retrieved by the CDC 204 from zone information (similar to the zone information 113 in FIG. 1) maintained by the CDC 204.

The management update information according to the example of Table 2 effectively defines an ACR that can be used by the ACR configuration engine 206 to configure the switch 202 with the ACR.

Based on the management update information received from the CDC 204, the ACR configuration engine 206 identifies (at 220) the switch 202 based on the switch IP address included in the management update information. Further, the ACR configuration engine 206 identifies (at 222) a switch port for which the ACR is to be configured based on the switch port name included in the management update information.

In addition, the ACR configuration engine 206 identifies (at 224) a type of interface to use for configuring the ACR at the switch 202 based on the switch vendor information in the management update information. Switches associated with a first vendor may employ a first type of interface, such as a Representational State Transfer (REST) application programming interface (API). Switches associated with a different second vendor may employ another type of interface, such as a Simple Object Access Protocol (SOAP) API. In other examples, switches may employ other types of interfaces.

The ACR configuration engine 206 programs (at 226) the ACR specified by the management update information in the switch 202. The programming uses the type of interface identified (at 224), and the ACR is configured for the switch port identified by the switch port name.

The above assumes that the management update information identifies just one switch on which the ACR is to be configured. In further examples, the CDC 204 can generate management update information that identifies multiple switches on which an ACR is to be configured.

In examples in which information between the client device 200 and the switch 202 is exchanged (at 214) in LLDP messages, an LLDP message may have the format according to Table 3 below, for example.

TABLE 3
(LLDP format)

| | | | | |
|---|---|---|---|---|
| Chassis ID | Port ID | Time to Live | Port | End of LLDP |
| | | (TTL) | Descriptor | Packet |

Each of the fields (Chassis ID, Port ID, TTL, Port Descriptor, and End of LLDP Packet) in the LLDP message may be a tag-length-value (TLV) field, where a tag identifies the type of field, the length specifies the length of the field, and the value includes the content of the field. In an LLDP message sent by the switch 202, the Chassis ID field can include the switch IP address and possibly a MAC address of the switch 202; the Port ID field can include the switch port name; the TTL indicates a length of time that the recipient of the LLDP message is to regard the information in the LLDP message as valid; the Port Descriptor field includes a description of the switch port; and the End of LLDP Packet field contains a value indicating the end of the LLDP message.

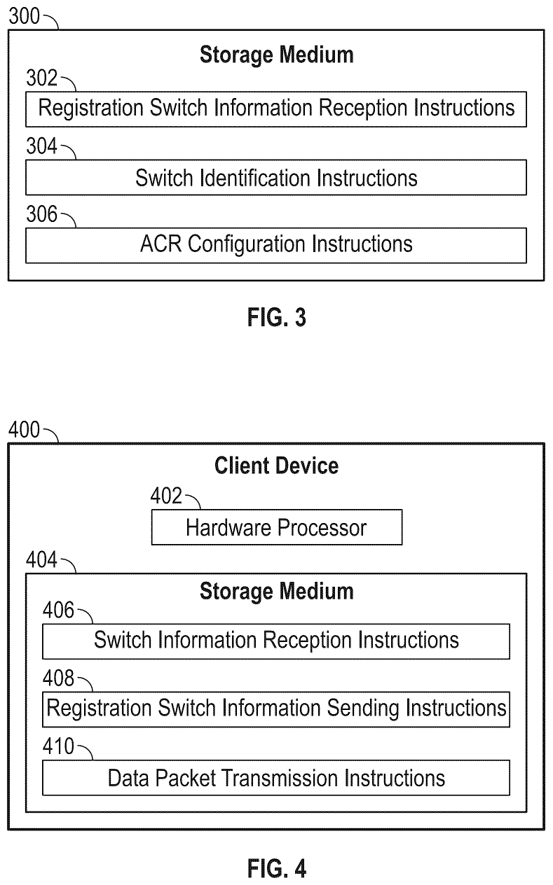

FIG. 3 is a block diagram of a non-transitory machine-readable or computer-readable storage medium 300 storing machine-readable instructions that upon execution cause a system to perform various tasks. The system can include one or more components to perform the tasks, such as a controller and a management system.

The machine-readable instructions include registration switch information reception instructions 302 to receive, at the controller, information from a client device as part of a registration process by the client device with the controller. The information received from the client device includes switch information of a switch to which the client device is connected. The switch being part of a network fabric that connects client devices to destination devices.

The machine-readable instructions include switch identification instructions 304 to identify, based on the switch information received from the client device, the switch from among a plurality of switches of the network fabric as a target to configure an ACR for a zone including the client device. For example, the switch can be identified based on a switch IP address of the switch included in the switch information.

The machine-readable instructions include ACR configuration instructions 306 to configure, at the switch, the ACR for the zone. The switch at which the ACR is configured is an ingress switch for the client device to allow the ingress switch to enforce the ACR in response to receipt of data packets from the client device.

In some examples, the identifying of the switch from among the plurality of switches is based on a policy of configuring ACRs at ingress switches.

In some examples, the controller includes an NVMe-OF discovery controller, and the registration process includes an NVMe DIM registration process.

In some examples, the switch information is carried in one or more attributes of a DIM command sent by the client device to initiate the DIM registration process.

In some examples, the identifying of the switch based on the switch information and the configuring of the ACR at the switch are performed by a management system, such as the management system 110 in FIG. 1. In other examples, the identifying of the switch based on the switch information and the configuring of the ACR at the switch can be performed by the controller, such as the CDC 112 or 114 in FIG. 1.

In some examples, the switch information received from the client device as part of the registration process can include a switch port name of a switch port of the switch, and/or a switch vendor name identifying a vendor or manufacturer of the switch.

In some examples, the machine-readable instructions can identify a type of interface to use for programming the ACR at the switch.

In some examples, the information including the switch information is received from the client device as part of an LLDP message sent by the switch to the client device.

In some examples, the configuring of the ACR at the switch is based on information in a JSON object containing the ACR.

In some examples, the JSON object is provided from the controller to a management system that configures the ACR at the switch.

FIG. 4 is a block diagram of a client device 400 according to some examples. The client device 400 may be a host device or another type of source electronic device that can initiate communication with a destination device.

The client device 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The client device 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include switch information reception instructions 406 to receive, at the client device 400 from a switch to which the client device 400 is connected, switch information of the switch. The switch information can include the switch IP address and possibly other information of the switch.

The machine-readable instructions in the storage medium 404 include registration switch information sending instructions 408 to send, from the client device 400 to a controller, the switch information as part of a registration process to register the client device 400 with the controller. The switch information sent as part of the registration process is useable to identify the switch on which an ACR is to be placed.

The machine-readable instructions in the storage medium 404 include data packet transmission instructions 410 to send a data packet from the client device 400 to the switch for receipt by a destination device, where the switch is to enforce the ACR with respect to the data packet.

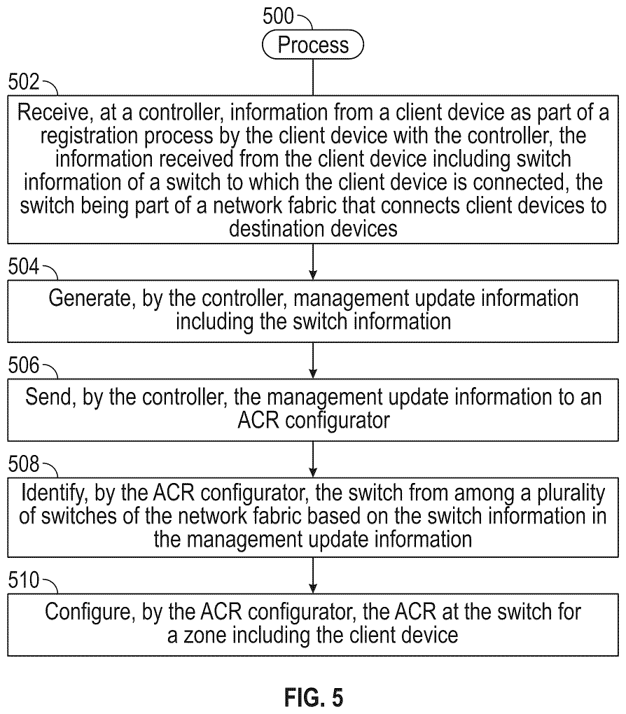

FIG. 5 is a flow diagram of a process 500 according to some examples of the present disclosure. The process 500 includes receiving (at 502), at a controller, information from a client device as part of a registration process by the client device with the controller, the information received from the client device including switch information of a switch to which the client device is connected, the switch being part of a network fabric that connects client devices to destination devices.

The process 500 includes generating (at 504), by the controller, management update information including the switch information. The management update information can be in the form of a JSON object, for example.

The process 500 includes sending (at 506), by the controller, the management update information to an ACR configurator, such as the ACR configuration engine 120 or 206 of FIG. 1 or 2, respectively. The management update information is to trigger the ACR configurator to being an ACR configuration process.

The process 500 includes identifying (at 508), by the ACR configurator, the switch from among a plurality of switches of a network fabric based on the switch information in the management update information. For example, the identification of the switch can be based on a switch IP address of the switch.

The process 500 includes configuring (at 510), by the ACR configurator, the ACR at the switch for a zone including the client device.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A “memory” can include one or more memory devices. A memory device can be implemented using any or some combination of the following: a dynamic or static random access memory (a DRAM or SRAM) device, an erasable and programmable read-only memory (EPROM) device, an electrically erasable and programmable read-only memory (EEPROM) device, or a flash memory device.

FIGS. 2 and 5 depict specific orders of tasks. In other examples, the tasks may be performed in a different order, some tasks may be omitted, or other tasks may be added.

A storage medium (e.g., 300 in FIG. 3 or 404 in FIG. 4) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive, at a controller, information from a client device as part of a registration process by the client device with the controller, the information received from the client device comprising switch information of a switch to which the client device is connected, the switch being part of a network fabric that connects client devices to destination devices; and
based on the switch information, identify the switch from among a plurality of switches of the network fabric as a target to configure an access control rule for a zone including the client device; and
configure, at the switch, the access control rule for the zone.

2. The non-transitory machine-readable storage medium of claim 1, wherein the identifying of the switch from among the plurality of switches is based on a policy of configuring access control rules at ingress switches.

3. The non-transitory machine-readable storage medium of claim 2, wherein the identified switch is an ingress switch for the client device based on the switch information.

4. The non-transitory machine-readable storage medium of claim 1, wherein the controller comprises a Non-Volatile Memory Express over Fabrics (NVMe-oF) discovery controller, and the registration process comprises a Discovery Information Management (DIM) registration process.

5. The non-transitory machine-readable storage medium of claim 4, wherein the switch information is carried in one or more attributes of a DIM command sent by the client device to initiate the DIM registration process.

6. The non-transitory machine-readable storage medium of claim 1, wherein the identifying of the switch based on the switch information and the configuring of the access control rule at the switch are performed by a management system.

7. The non-transitory machine-readable storage medium of claim 6, wherein the controller is to send the switch information received from the client device to the management system.

8. The non-transitory machine-readable storage medium of claim 1, wherein the switch information received from the client device as part of the registration process comprises an Internet Protocol (IP) address of the switch.

9. The non-transitory machine-readable storage medium of claim 8, wherein the switch information received from the client device as part of the registration process further comprises a switch port name of a switch port of the switch.

10. The non-transitory machine-readable storage medium of claim 8, wherein the switch information received from the client device as part of the registration process further comprises a switch vendor name identifying a vendor or manufacturer of the switch.

11. The non-transitory machine-readable storage medium of claim 10, wherein the instructions upon execution cause the system to:
identify a type of interface to use for programming the access control rule at the switch.

12. The non-transitory machine-readable storage medium of claim 1, wherein the information comprising the switch information is received from the client device as part of a Link Layer Discovery Protocol (LLDP) message sent by the switch to the client device.

13. The non-transitory machine-readable storage medium of claim 1, wherein the configuring of the access control rule at the switch is based on information in a JavaScript Object Notation (JSON) object containing the access control rule.

14. The non-transitory machine-readable storage medium of claim 13, wherein the JSON object is provided from the controller to a management system that configures the access control rule at the switch.

15. A client device comprising:
a hardware processor; and
a non-transitory storage medium storing instructions executable on the hardware processor to:
receive, from a switch to which the client device is connected, switch information of the switch;
send, from the client device to a controller, the switch information as part of a registration process to register the client device with the controller, the switch information sent as part of the registration process useable to identify the switch on which an access control rule is to be placed; and
send a data packet from the client device to the switch for receipt by a destination device, the switch to enforce the access control rule with respect to the data packet.

16. The client device of claim 15, wherein the registration process comprises a registration process according to a Non-Volatile Memory Express over Fabrics (NVMe) protocol, and wherein the controller comprises a centralized discovery controller (CDC).

17. The client device of claim 15, wherein the switch information sent to the controller as part of the registration process comprises an Internet Protocol (IP) address of the switch.

18. A method comprising:
receiving, at a controller, information from a client device as part of a registration process by the client device with the controller, the information received from the client device comprising switch information of a switch to which the client device is connected, the switch being part of a network fabric that connects client devices to destination devices;
generating, by the controller, management update information comprising the switch information;
sending, by the controller, the management update information to an access control rule configurator;
identifying, by the access control rule configurator, the switch from among a plurality of switches of the network fabric based on the switch information in the management update information; and
configuring, by the access control rule configurator, an access control rule at the switch for a zone including the client device.

19. The method of claim 18, wherein the controller comprises a Non-Volatile Memory Express over Fabrics (NVMe-oF) discovery controller, and the registration process comprises a Discovery Information Management (DIM) registration process.

20. The method of claim 18, wherein the switch information received from the client device as part of the registration process comprises an Internet Protocol (IP) address of the switch, a switch port name of a switch port of the switch, and a switch vendor name identifying a vendor or manufacturer of the switch.
